(19) United States
(12) Patent Application Publication
(10) Pub. No.: US 2006/0097209 A1
(43) Pub. Date: May 11, 2006

(54) Ball retainer for vehicle solenoid valve

(76) Inventors: Luis F. Barron, El Paso, TX (US); Alejandro Moreno, El Paso, TX (US)

Correspondence Address: JIMMY L. FUNKE;DELPHI TECHNOLOGIES, INC., Mail Code: 480-410-202, P.O. Box 5052, Troy, MI, 48007-5052, US

(21) Appl. No.: 10/984,385

(22) Filed: Nov. 9, 2004

(51) Int. Cl. F16K 31/02

(52) U.S. Cl. 251/129.15

(57) ABSTRACT

In a vehicle solenoid valve that can be energized to move a plunger against a ball and unseat the ball to open the valve, a cross bar retainer extends across the middle of the fluid passageway on the side of the ball opposite the seat, to limit motion of the ball away from the seat when it is pushed off the seat by the plunger.

### I. FIELD OF THE INVENTION

The present invention relates generally to vehicle solenoid valves.

### II,BACKGROUND

Many vehicle systems such as anti-lock brake systems and ride control systems use hydraulics to actuate control components to achieve the desired result, e.g., to prevent brakes from locking under certain driving conditions. To control the flow of hydraulic fluid through these systems, computer-controlled solenoid valves are used and are operated as necessary to permit or prohibit hydraulic fluid flow through various systems components, typically in response to sensor signals that are input to the vehicle's onboard computer which controls the valves.

The valves can be two-way valves or three-way valves, but in any case one type of fundamental construction of a vehicle hydraulic valve includes an armature having a plunger that reciprocates in the valve housing when a solenoid surrounding the armature is energized and de-energized. On the end of the plunger is a pin, and when the solenoid is energized the plunger slides such that the pin extends through a valve seat in the body to contact a ball and move the ball away from the seat, thereby opening up the fluid passageway through the seat. When the solenoid is de-energized the plunger moves back, and fluid pressure in the system pushes the ball back against the seat to close the valve.

To prevent the ball from being pushed out of the valve by the pin when the valve is open, a retainer ring can be attached to (e.g., by press fitting into) the valve body, with the ball being located between the seat and the ring and with enough space existing between the ring and seat to allow the ball to move between the two. The retainer ring keeps the ball in the valve body.

The present invention makes the following critical observations regarding the structure discussed above. As the ball moves toward the retainer ring during the opening process, the fluid flow dynamics through the valve can fluctuate in a way that can cause the ball to move away from and then back against the pin, repeatedly striking the pin relatively hard. This undesirably can cause fatigue fractures of the pin and/or plastic deformation of the pin. Also, an undesirable bouncing effect can be produced on the actuator armature. As well, undesirable pressure fluctuations can occur in the valve, including at the control port through which fluid flows to the component being controlled.

### SUMMARY OF THE INVENTION

An actuator valve includes a body that defines at least a first port, a second port, and a valve seat between the ports. A central axis extends between the ports through the center of the valve seat. A ball is juxtaposed with the valve seat for blocking the seat. Also, a plunger assembly is reciprocatingly disposed in the housing for moving the ball away from the seat. In accordance with the present invention, a cross member is coupled to the valve body and extends across the central axis. The cross member contacts the ball when the plunger distances the ball from the seat to limit movement of the ball away from the seat.

In one implementation a ball retainer ring can be disposed opposite the ball from the seat and can have a diameter that is less then the diameter of the ball. In this implementation, the cross member is made integrally with the ball retainer ring and defines a diameter thereof. In another implementation the cross member can be pressed or sandwiched within a transverse slot or hole at an end ring and/or a flange defined by the body. In still another implementation the cross member can be flexible and its ends can be disposed in a member retaining groove that is formed in the body.

In another aspect, a solenoid valve includes a plunger biased to a closed position and a coil that can be energized to move the plunger to an open position. A ball is disposed in a fluid passageway between first and second fluid ports, and the ball blocks the fluid passageway when the plunger is in the closed position. The ball can be moved by the plunger to unblock the fluid passageway when the coil is energized. A cross member extends across the fluid passageway and is positioned to limit the motion of the ball away from the plunger.

In yet another aspect, a method is disclosed for establishing fluid communication through a fluid passageway of a solenoid valve. The fluid passageway defines a central axis and the method includes moving a ball in the fluid passageway to distance the ball from a valve seat and thereby establish fluid communication through the fluid passageway. The method also includes contacting the ball at a location on its surface that is substantially on the central axis to limit motion of the ball away from the seat.

In still another aspect, a solenoid valve is formed with a fluid passageway defining a central axis. The valve includes means for moving a ball in the fluid passageway to distance the ball from a valve seat, thereby establishing fluid communication through the fluid passageway. Also, the valve has means for contacting the ball at a location on its surface that is substantially on the central axis to limit motion of the ball away from the seat.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a cross-sectional view of a first embodiment of the valve, showing the valve in the closed (de-energized) configuration;

FIG. 2 is an enlarged view of the seat portion of the valve shown in FIG. 1, with portions of the valve body broken away, showing the valve in the closed (de-energized) configuration;

FIG. 3 is a plan view of an embodiment of the present cross bar retainer implemented in a retainer ring;

FIG. 4 is a cross-sectional view of a second embodiment of the valve, showing the present cross bar retainer in a second implementation;

FIG. 5 is a cross-sectional view of a second embodiment of the valve, showing the present cross bar retainer in a third implementation; and

FIG. 6 is a simplified schematic block diagram showing the present valve in one intended environment.

### DETAILED DESCRIPTION OF THE PREFERRED EMBODIMENT

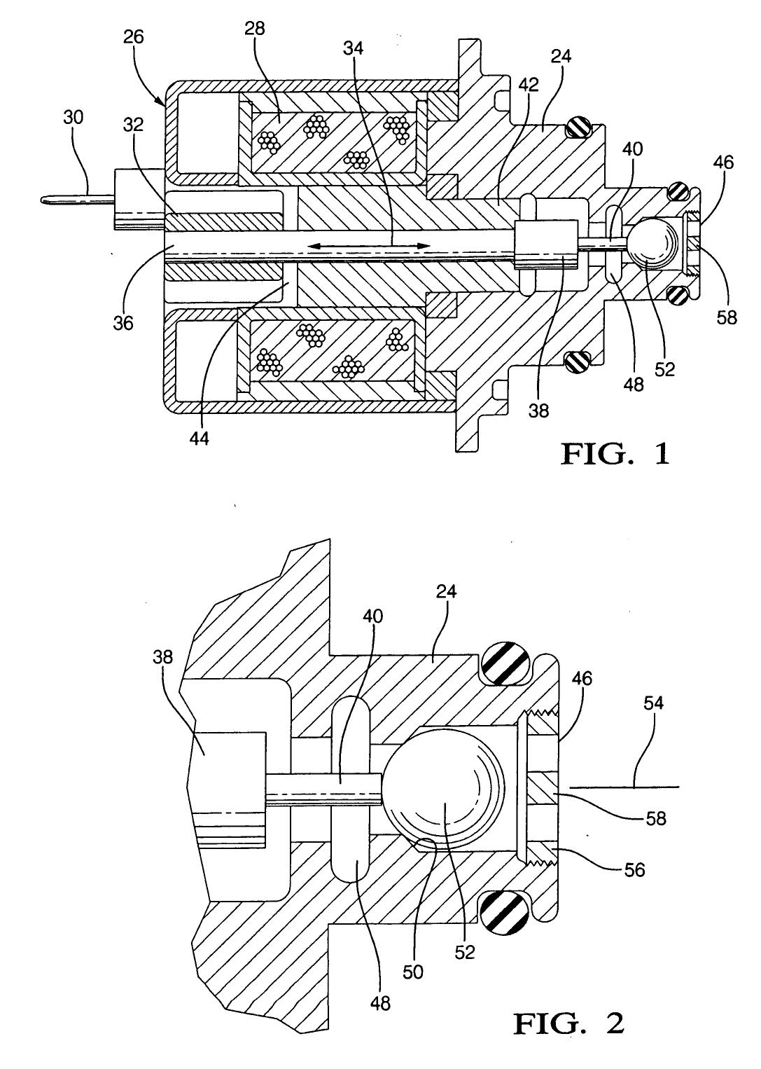

Referring initially to FIG. 1, a solenoid-operated control valve 10 includes a rigid metal (or, if desired, high strength plastic) valve body 24 that extends partially into a solenoid can 26. A toroidal wire solenoid coil 28 is disposed in a solenoid bay formed between the can 26 and valve body 24. The solenoid can be energized by means of power sent to the solenoid through a connector or terminals 30 (only one connector or terminal 30 shown in the figure), which is electrically connected to the coil 28.

A plunger 32 is reciprocatingly disposed within the valve 24 as indicated by the arrows 34, and is biased (by, e.g., a spring or by fluid pressure) to assume the closed position shown when the coil 28 is de-energized. The plunger can include an elongated rigid plunger rod 36 that can be formed with an enlarged plunger head 38 extending from which is an elongated thin pin 40. A stationary bushing 42 may also be provided to support and guide the plunger rod 36 as shown, with an air gap 44 being established between the bushing 42 and plunger 32 as shown to permit axial motion of the plunger. Various o-rings and washers are also shown in FIG. 1 for engagement and sealing functions known to those skilled in the art.

As perhaps best shown in FIG. 2, the valve body 24 forms at least two fluid ports, namely, a fluid supply port 46 (which can be connected to the fluid supply shown in FIG. 6 and discussed further below) and a control port 48 (which can be connected to the component shown in FIG. 6 and discussed further below). The valve 10 can be a three port valve if desired that may include an exhaust port (not shown) as well. To selectively establish fluid flow between the two ports 46, 48 the valve body 24 can be formed with a preferably conical valve seat 50 between the ports 46, 48, and a ball 52 can be seated against the seat 50 by fluid pressure from the supply port 46 to close the valve when the solenoid coil 28 is de-energized and to be pushed away from the seat 50 by the plunger pin 40 to open the valve when the solenoid coil 26 is energized to move the plunger to an open position.

FIG. 2 shows that a central axis 54 is defined by the above structure. Specifically, the central axis 54 extends between the ports 46,48 through the center of the valve seat 50. A ball retainer ring 56 is formed on or is engaged with the valve body 24 by, e.g., press-fitting, ultrasonic welding, or snapping engagement, and the retainer ring 56 circumscribes the axis 54. The inside diameter of the retainer ring 56 may be (but is not necessarily) less than the diameter of the ball 52, and the ball 52 can move within the valve body 24 between the retainer ring 56 on one side and the valve seat 50 on the other.

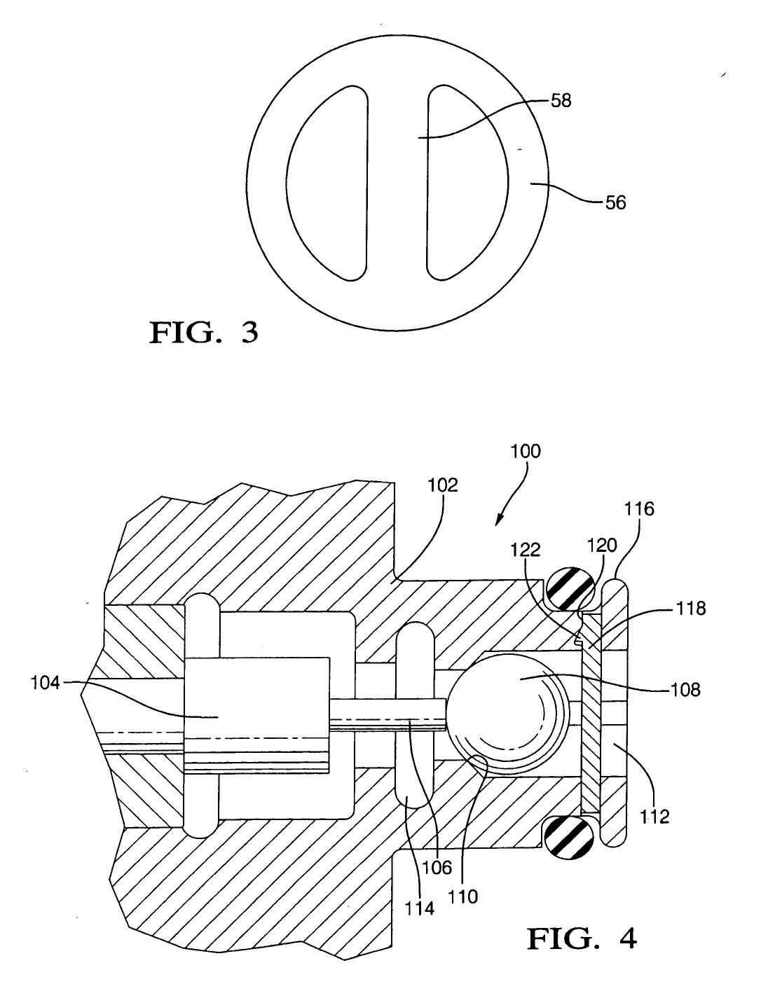

In accordance with the present invention, a cross member 58 is coupled to the valve body 24, and the cross member 58 extends across the central axis 54 as shown. As intended herein, the cross member 58 can contact the ball 52 to limit movement of the ball 52 away from the seat 50. In the particular embodiment shown in FIGS. 1-3, the cross member 58 is engaged with the ball retainer ring 56 and more specifically may be made integrally with the ball retainer ring 56 as shown in FIG. 3, such that the cross member 58 defines a diameter of the ring 56. The cross member 58 may have a round cross-section, or a rectangular cross-section, or a triangular cross-section, or any other suitable cross-section.

With the combination of structure discussed above, it may now be appreciated that the cross member 58 limits the motion of the ball 52 away from the seat 50 more than the retainer ring 56 alone (i.e., without a cross member) would limit motion, because the cross member 58 contacts the surface of the ball 52 at a location of the ball that is on the central axis 54 and, thus, before any portion of the ball 52 is able to break the plane of the retainer ring 56.

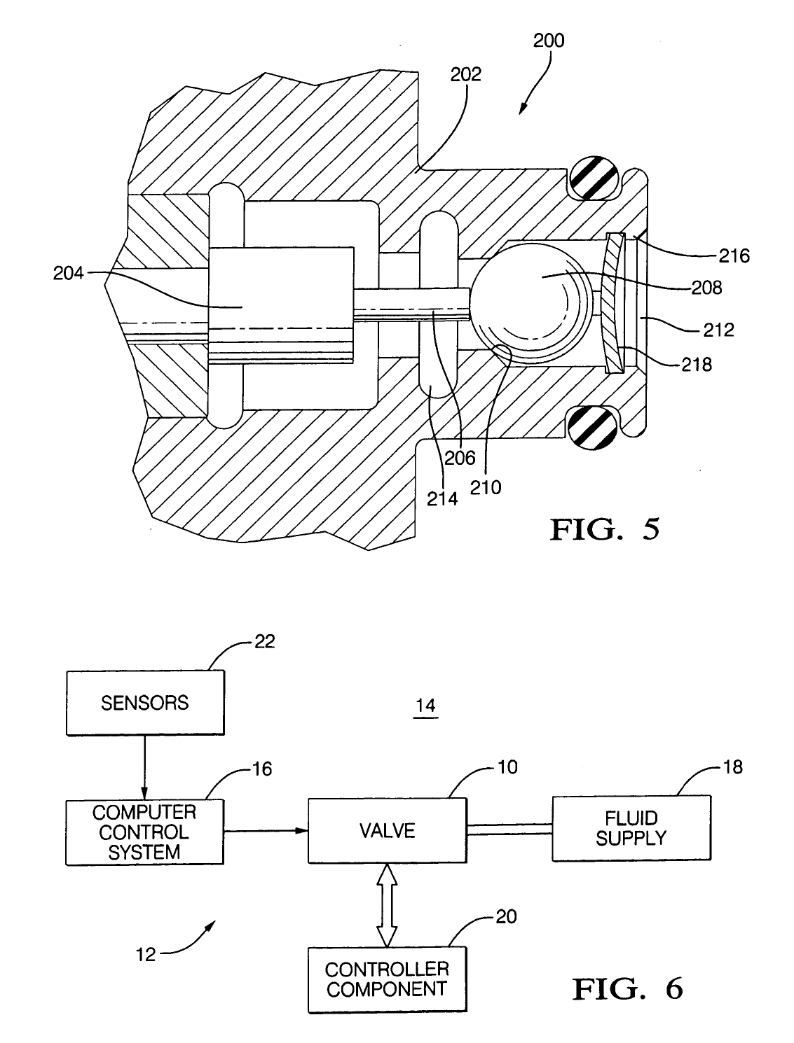

FIGS. 4 and 5 (rotated 90° about the central axis from FIG. 2) show alternate implementations of the cross member, it being understood that the valves shown in FIGS. 4 and 5 are in all essential respects identical in construction and operation to the valve 10 shown in FIGS. 1-3. Accordingly, a valve 100 in FIG. 4 has a valve body 102 and plunger 104 with rod and head reciprocatingly disposed therein. The plunger 104 rod has a pin 106 that can contact a ball 108 to move the ball 108 away from a seat 110 that is formed by the valve body 102. The valve body 102 forms a supply port 112 and a control port 114, and when the ball 108 is distanced from the seat 110 upon energization of the valve solenoid, fluid can flow from port to port. When the solenoid is de-energized the ball 108 is pushed against the seat 110 by fluid pressure, closing the valve.

In accordance with the embodiment shown in FIG. 4, an end ring portion 116 is defined on the valve body 102 by a passageway 118 that is formed transversely through the body by molding or machining. The end ring portion 116 circumscribes the supply port 112 as shown, or it may be axially located just interior to the supply port. In any case, a cross member 120 is closely received in the passageway 118, i.e., the cross member 120 is sandwiched between the end ring 116 and the remainder of the valve body 102. Like the cross member shown in FIGS. 1-3, the cross member 120 shown in FIG. 4 extends across the central axis of the fluid passageway that is defined between the ports 112, 114. If desired, the cross member 120 can be formed with a protruding detent 122 that can engage a complementarily-shaped cavity or have an interference fit with the valve body to more firmly hold the cross member 120 in place. With this structure, the cross member 120 can be axially or side load “pressed” into the passageway 118 for retention.

FIG. 5 shows a valve 200 that has a valve body 202 and plunger rod 204 reciprocatingly disposed therein. The plunger rod 204 has a pin 206 that can contact a ball 208 to move the ball 208 away from a seat 210 that is formed by the valve body 202. The valve body 202 forms a supply port 212 and a control port 214, and when the ball 208 is distanced from the seat 210 upon energization of the valve solenoid, fluid can flow from port to port. When the solenoid is de-energized the ball 208 is pushed against the seat 210 by fluid pressure, closing the valve.

As shown in FIG. 5, the valve body 202 can be formed with a radial groove 216 that is axially located just interior to the supply port 212. Whereas the preceding cross members can be rigid, in FIG. 5 a flexible cross member 218 can be pushed through the supply port 212 until its opposed ends snap into the groove 216. If desired, the length of the cross member 218 can be marginally greater than the diameter of the groove 216, so that when it is pushed into place it assumes the convex configuration shown in FIG. 5. With this convex configuration the ball 208 can move even less of a distance away from its seat than is the case with the previously discussed balls 52, 108. Similarly, in the absence of a groove, the length of a flexible cross member can be such that axial force along the cross member pushes against the inner diameter surface of the valve body and hold the position of the cross member through friction.

In the non-limiting implementations discussed above, the cross members are generally elongated and parallelepiped-shaped. They are made of metal but can also be made of plastic in less preferred embodiments.

FIG. 6 shows any of the above valves in an exemplary embodiment. For illustration, the valve 10 is shown in a hydraulic system 12 of a vehicle 14. The valve can be operated under the control of a computer control system 16 to direct fluid between a fluid supply 18 and a component 20 to be controlled in accordance with various principles known in the art, e.g., in accordance with ABS principles in which case the component 20 might be a braking component. The computer system 16 might control the valve 10 in response to signals from various sensors 22, e.g., skid or slide sensors.

In any case, while the simplified diagram of FIG. 6 shows only a single valve 10, it is to be understood that more than a single valve (and more than a single component to be controlled) can be implemented.

While the particular BALL RETAINER FOR VEHICLE SOLENOID VALVE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. An actuator valve, comprising:
a body defining at least a first port, a second port, and a valve seat therebetween, a central axis extending between the ports through the center of the valve seat;
a ball juxtaposed with the valve seat for blocking the seat;
a plunger assembly reciprocatingly disposed in the housing for moving the ball away from the seat; and
a cross member coupled to the valve body and extending across the central axis, the cross member disposed to contact the ball to limit movement of the ball away from the seat.

2. The valve of claim 1, comprising a ball retainer ring disposed opposite the ball from the seat and having a diameter less then the diameter of the ball, the cross member being engaged with the ball retainer ring.

3. The valve of claim 2, wherein the cross member is made integrally with the ball retainer ring and defines a diameter thereof.

4. The valve of claim 1, wherein the cross member is disposed in a passageway defined by the body.

5. The valve of claim 1, wherein the cross member is flexible and defines opposed ends.

6. The valve of claim 5, wherein the ends of the cross member are disposed in a member retaining groove formed in the body.

7. The valve of claim 1, in combination with a motor vehicle.

8. A solenoid valve, comprising:
a plunger biased to a closed position;
a coil energizable to move the plunger to an open position;
a ball disposed in a fluid passageway between first and second fluid ports, the ball blocking the fluid passageway when the plunger is in the closed position, the ball being moved by the plunger to unblock the fluid passageway when the coil is energized; and
a cross member extending across the fluid passageway and positioned to limit the motion of the ball away from the plunger.

9. The valve of claim 8, comprising a valve body.

10. The valve of claim 9, wherein a central axis extends between the ports through the center of a valve seat defined by the valve body, and the cross member extends across the central axis.

11. The valve of claim 10, comprising a ball retainer ring disposed opposite the ball from the seat and having a diameter less then the diameter of the ball, the cross member being engaged with the ball retainer ring.

12. The valve of claim 11, wherein the cross member is made integrally with the ball retainer ring and defines a diameter thereof.

13. The valve of claim 9, wherein the cross member is disposed in a passageway defined by the body.

14. The valve of claim 9, wherein the cross member is flexible and defines opposed ends.

15. The valve of claim 14, wherein the ends of the cross member are disposed in a member retaining groove formed in the body.

16. The valve of claim 8, in combination with a motor vehicle.

17. A method for establishing fluid communication through a fluid passageway of a solenoid valve, the fluid passageway defining a central axis, the method comprising:
moving a ball in the fluid passageway to distance the ball from a valve seat, thereby establishing fluid communication through the fluid passageway; and
contacting the ball at a location on its surface that is substantially on the central axis to limit motion of the ball away from the seat.

18. A solenoid valve formed with a fluid passageway defining a central axis, comprising:
means for moving a ball in the fluid passageway to distance the ball from a valve seat, thereby establishing fluid communication through the fluid passageway; and
means for contacting the ball at a location on its surface that is substantially on the central axis to limit motion of the ball away from the seat.

19. The valve of claim 18, wherein the means for contacting includes at least one cross member.

20. The valve of claim 18, in combination with a motor vehicle.
